(19) United States
(12) Patent Application Publication
(10) Pub. No.: US 2006/0101931 A1
(43) Pub. Date: May 18, 2006

(54) Adjusting device for positioning a load

(76) Inventor: Juergen Zimmermann, Bregenz (AT)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/274,525

(22) Filed: Nov. 15, 2005

(30) Foreign Application Priority Data
Nov. 17, 2004 (AT) GM 831/2004

(51) Int. Cl. F16H 25/20

(52) U.S. Cl. 74/89.23

(57) ABSTRACT

An adjusting device for positioning a load comprises a spindle and a spindle nut which is arranged on the spindle. Either the spindle nut is supported in a gear housing so as to be rotatable and not axially displaceable and the spindle is axially adjustable by rotating the spindle nut for positioning the load, or the spindle is supported in the gear housing so as to be rotatable and not axially displaceable and the spindle nut is axially adjustable by rotating the spindle for positioning the load. The gear housing has blind holes on two oppositely located housing sides and the swivel bearing bushes are pressed into these blind holes for receiving swivel pins.

### CROSS-REFERENCE TO RELATED APPLICATIONS

This application claims priority of Austrian Application No. GM 831/2004, filed Nov. 17, 2004, the complete disclosure of which is hereby incorporated by reference.

### BACKGROUND OF THE INVENTION

a) Field of the Invention

The invention is directed to an adjusting device for positioning a load, comprising a spindle, a spindle nut which is arranged on the spindle, and a gear housing in which either the spindle nut is supported so as to be rotatable and not axially displaceable, wherein the spindle is axially adjustable by rotating the spindle nut for positioning the load, or in which the spindle is supported so as to be rotatable and not axially displaceable, wherein the spindle nut is axially adjustable by rotating the spindle for positioning the load.

b) Description of the Related Art

Adjusting devices of the type mentioned above are known and are also called spindle lifting gear units, spindle nut gear units, or actuating drive units. Adjusting devices of this type are used for positioning loads in the form of structural component parts or component groups. For example, these adjusting devices are used in lifting platforms, lifting jacks, vertically adjustable platforms, valves with valve slides that are adjustable by motor, forms for concrete that are adjustable by motor, and so on.

Aside from spindle nut gear units in which the carrying nut is rotatably supported in a gear housing and which, when rotated, move a nonrotatable spindle in axial direction, there are also known spindle nut gear units in which the spindle is rotatably supported in the gear housing and in which, by rotating the spindle, a nut that is arranged on its external thread and fixed against rotation is moved in axial direction of the spindle.

In applications in which a swiveling actuation of a load around a swiveling axis is carried out, the swiveling of the load also brings about a (smaller) swiveling of the gear housing of the adjusting device around a swiveling axis. To enable a swivelable bearing support of the gear housing for applications of this type, adapter pieces are provided on which the gear housing can be screwed and which have swivel bearing bushes or swivel bearing pins. Cooperating with these swivel bearing bushes or swivel bearing pins of the adapter part are swivel bearing pins or swivel bearing bushes that are arranged at a stationary part and relative to which the load is to be swiveled around a swiveling axis. Further, the load is swivelable with the spindle (in case the spindle is axially displaceable) or with the spindle nut (in case the spindle nut is axially displaceable). Also, a swivelable bearing support of the adapter part connected to the gear housing can be provided at the swivelable load and a swivelable bearing support of the axially adjustable spindle or axially adjustable spindle nut can be provided at a stationary carrying part. This conventional solution is disadvantageous because of the relatively high additional costs of the adapter part which is to be connected to the gear housing and by which the swiveling bearing support is produced.

### OBJECT AND SUMMARY OF THE INVENTION

An important object of the invention is to provide an improved adjusting device of the type mentioned in the beginning in which the swiveling actuation of loads is achieved more economically compared to conventional adjusting devices.

This object is met, according to the invention, by an adjusting device for positioning a load, comprising a spindle, a spindle nut which is arranged on the spindle, and a gear housing in which either the spindle nut is supported so as to be rotatable and not axially displaceable, wherein the spindle is axially adjustable by rotating the spindle nut for positioning the load, or in which the spindle is supported so as to be rotatable and not axially displaceable, wherein the spindle nut is axially adjustable by rotating the spindle for positioning the load, wherein the gear housing has, on two oppositely located housing sides, blind holes into which the swivel bearing bushes are pressed for receiving swivel pins.

Because the swivel bearing support is integrated in the gear housing, no additional adapter parts which have to be fastened to the gear housing are required for executing swiveling operations of loads, which results in a more economical adjusting device for swiveling operations.

Further advantages and details of the invention are described in the following with reference to the embodiment example shown in the drawing, from which further objects of the invention follow.

### BRIEF DESCRIPTION OF THE DRAWINGS

In the drawings:

FIGS. 1 and 2 are side views showing opposite sides of the gear housing of an adjusting device according to an embodiment form of the invention;

FIGS. 3 and 4 are oblique views of the gear housing from FIGS. 1 and 2 from different viewing angles, obliquely from above in each case;

FIG. 5 shows an oblique view of the gear housing, wherein the sliding bearing bushes are shown outside of the blind holes of the gear housing in an exploded view;

FIG. 6 shows a longitudinal section through an adjusting device according to this embodiment example of the invention (section line A-A of FIG. 1), wherein only portions of the spindle are shown;

FIG. 7 is an oblique view of the adjusting device according to this embodiment form of the invention in an application for swiveling actuation of a structural component part; and

FIG. 8 shows an oblique view of a bearing bracket for swiveling bearing support of the gear housing.

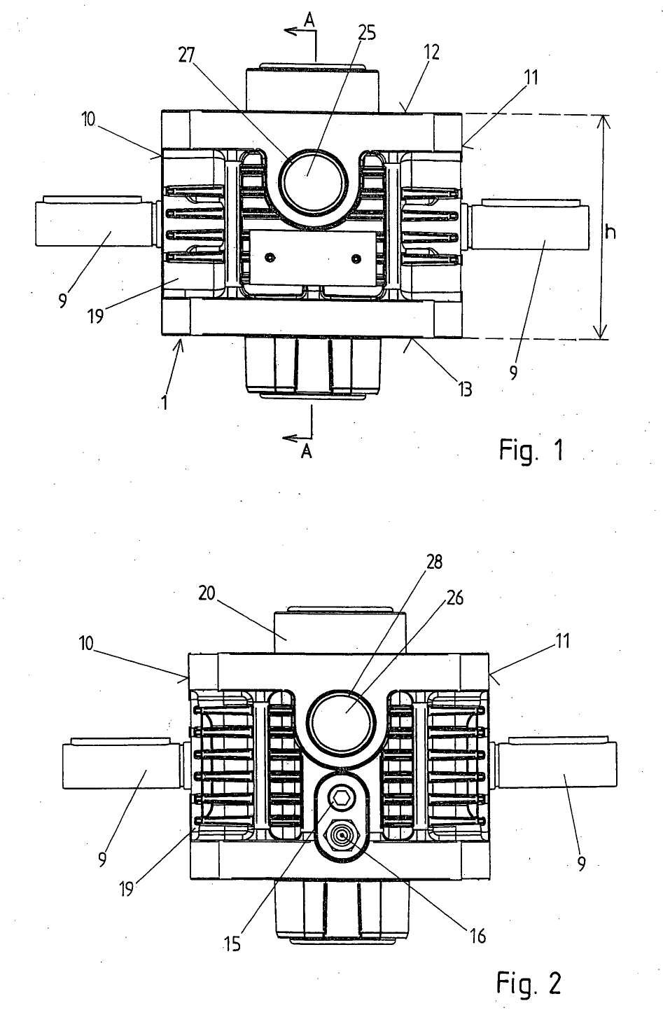

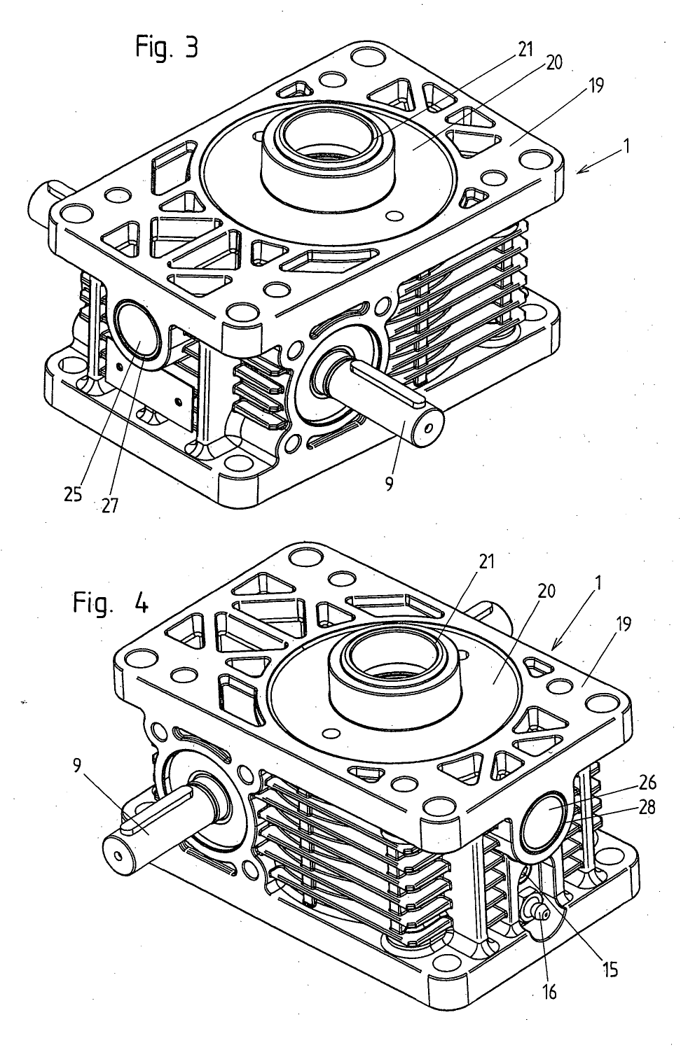

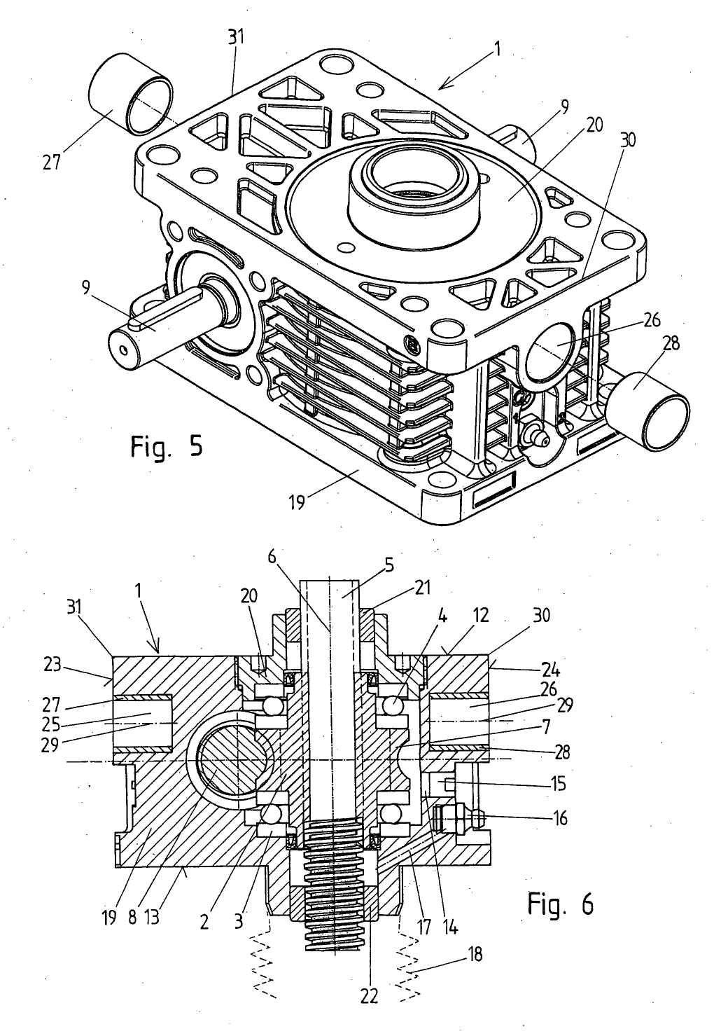

### DESCRIPTION OF THE PREFERRED EMBODIMENTS

In the embodiment example of the invention shown in the drawings, a spindle nut 2 is supported in the gear housing 1 by axial bearings 3, 4 so as to be rotatable and not displaceable axially. The spindle nut 2 is arranged with its internal thread on the external thread of a spindle 5 which is displaceable axially, i.e., in direction of its longitudinal axis 6, by rotation of the spindle nut 2. The external thread of the spindle 5 can be constructed, e.g., in the form of a trapezoidal thread.

For rotation of the spindle nut 2, this spindle nut 2 has an external toothing 7 which engages with the toothing of a driving wheel 8. The external toothing 7 can be formed, for example, as a worm toothing and the driving wheel 8 can be constructed as a worm. The driving wheel 8 is driven by a driveshaft 9 which projects from opposite sides 10, 11 of the gear housing 1 in the embodiment example shown in the drawing. The rotatable bearing support of the driving wheel 8 can be carried out, for example, by means of a rotatable bearing support of the driveshaft 9 by radial bearings, not shown in the drawings, which are arranged on both sides of the driving wheel 8.

The spindle 5 projects out of the gear housing 1 in the area of upper and lower housing sides 12, 13.

A lubricant can be introduced through the fill hole 14 after unscrewing a closure screw 15. Likewise, a lubricant (the same or a different lubricant) can be introduced through the lubricating nipple 16 and the lubricating bore 17.

The portion of the spindle 5 which projects out of the gear housing 1 and at whose end is arranged the load to be adjusted can be enclosed by bellows 18 which are only shown in dashes in FIG. 6.

The gear housing 1 comprises a housing base part 19 and a housing cover 20 which is screwed to the housing base part and through which the spindle 5 is guided out of the gear housing 1 on one side 12 thereof. Bushes 21, 22 are pressed into the outlet openings of the housing base part 19 and of the housing cover 20 for the spindle 5. In normal operation, the bushes 21, 22 are separated from the external thread of the spindle 5 by a gap. In the event that a lateral load acts on the spindle 5 so that the spindle 5 is pressed against the inner wall of the bush 21 or 22, the bush 21, 22 also serves as a radial guide for the spindle 5. For this purpose, the bush 21, 22 is made of a material with corresponding sliding properties, preferably bronze.

The housing base part 19 is constructed as a cast metal part. Blind holes 25, 26 are arranged in the housing base part 19 at opposite housing sides 23, 24, tubular swivel bearing bushes (sliding bushes) 27, 28 being pressed into these blind holes 25, 26. The swivel bearing bushes 27, 28 serve to receive swivel pins so as to support the gear housing 1 in a swivelable manner to form a swiveling drive. The swivel bearing bushes 27, 28 can be constructed, for example, in the form of bronze-coated steel bushes. The axes 29 of the swivel bearing bushes 27, 28 are aligned with one another and extend at right angles to the longitudinal axis 6 of the spindle. Accordingly, the housing sides 23, 24 in which the blind holes 25, 26 are arranged with the pressed in swivel bearing bushes 27, 28 extend at right angles to the housing sides 12, 13 which are penetrated by the spindle 5.

In the embodiment example shown in the drawing, the axes 29 of the swivel bearing bushes 27, 28 extend at right angles to the driveshaft 9, and the housing sides 23, 24 in which the blind holes 25, 26 are arranged with the swivel bearing bushes 27, 28 extend at right angles to the housing sides 10, 11 which are penetrated by the driveshaft 9.

Further, it is advantageous when the axes 29 of the swivel bearing bushes 27, 28 are at a distance from the load-side edge 30, 31 of the respective housing side 23, 24 at which they are arranged, which distance is less than half, preferably less than two fifths, of the height h of the gear housing 1 measured in axial direction of the spindle 5. The deflection of the spindle 5 by the load acting on it is accordingly kept as small as possible.

The blind holes 25, 26 are formed when the housing base part 19 is cast and are subsequently drilled to the precise desired diameter. The swivel bearing bushes 27, 28 are pressed in subsequently.

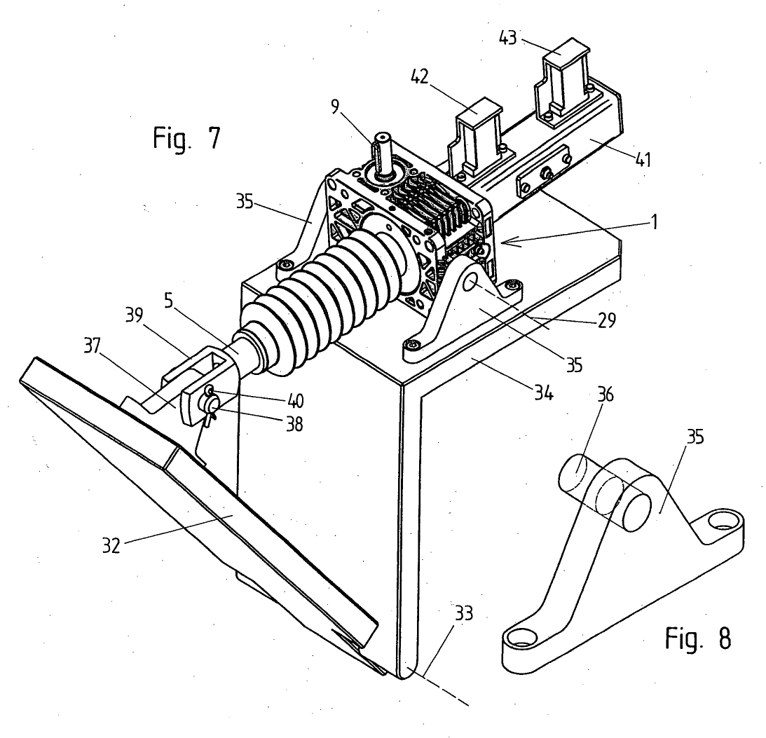

FIG. 7 shows an embodiment example of a possible application of an adjusting device according to this embodiment form. A load 32 is supported at a stationary part 34 so as to be swivelable around a swiveling axis 33. Bearing brackets 35 having swivel pins 36 (see FIG. 8) are arranged at the stationary part 34. The swivel pins 36 project into the swivel bearing bushes 27, 28 that are pressed into the blind holes 25, 26 at the opposite housing sides 23, 24 so that the gear housing 1 is supported so as to be swivelable around the axis 29 of the swivel bearing bushes 27, 28. A bearing bracket 37 arranged at the load 32 has a bore hole that is penetrated by a pin 38 which projects through bore holes in a fork 39 and which is secured by a cotter pin 40. The fork 39 is arranged at the end of the spindle 5. In this way, the load 32 is swivelably connected to the spindle 5.

The portion of the spindle 5 projecting from the gear housing 1 on the other side projects into a rectangular tube 41. A block (not visible in FIG. 7) can be fastened to the end of this portion of the spindle 5, which block is supported in the rectangular tube 41 so as to be displaceable but not rotatable relative to it in order to prevent the spindle 5 from rotating. These means for preventing the rotation of the spindle 5 can also be formed by the fastening to the load 32. Further, limit switches 42, 43 which limit the swiveling angle for the load 32 cooperate with the portion of the spindle 25 projecting into the rectangular tube 41.

For purposes of swiveling the load 32, the driveshaft 9 is driven by a drive motor, not shown, so that the spindle nut 2 is rotated by the driving wheel 8 and the spindle 5 is displaced axially. When the load 32 is swiveled around the swiveling axis 33, the gear housing 1 also swivels around the axis 29 of the swivel bearing bush 27, 28. Further, the load 32 swivels around the pin 38 relative to the spindle 5.

Different modifications of the embodiment example shown herein are conceivable and possible without departing from the field of the invention. For example, the housing base part 19 could also be made from a plurality of cast metal parts that are connected to one another. In that case, the screw-on housing cover 20 could also be dispensed with. On the other hand, a plurality of screw-on housing covers could also be provided.

In the embodiment example shown herein, a spindle nut 2 is supported in the gear housing so as to be rotatable but not axially displaceable so that the spindle which is fixed with respect to rotation can be adjusted axially. Instead of this, the spindle could also be supported in the gear housing so as to be rotatable and not displaceable axially and could be rotated by means of a driving wheel which is connected to a driveshaft. Normally, in a construction of this kind the spindle projects out of the housing only on one side of the latter. In this case, the spindle nut arranged on the external thread of the spindle is adjusted in axial direction of the spindle when the spindle is rotated. The spindle nut is fixed with respect to rotation through its connection to the load to be adjusted.

As follows from the preceding description, the field of the invention is not limited to the embodiment examples shown herein, but rather should be defined with reference to the appended claims together with their full range of possible equivalents.

While the preceding description and drawings show the invention, it is obvious to the person skilled in the art that various modifications can be carried out without departing from the spirit of and field of the invention.

Reference numbers:

1 gear housing

2 spindle nut

3 axial bearing

4 axial bearing

5 spindle

6 longitudinal axis

7 external toothing

8 driving wheel

9 driveshaft

10 housing side

11 housing side

12 housing side

13 housing side

14 fill hole

15 closure screw

16 lubricating nipple

17 lubricating bore

18 bellows

19 housing base part

20 housing cover

21 bush

22 bush

23 housing side

24 housing side

25 blind hole

26 blind hole

27 swivel bearing bush

28 swivel bearing bush

29 axis

30 edge

31 edge

32 load

33 swiveling axis

34 part

35 bearing bracket

36 swiveling pin

37 bearing bracket

38 pin

39 fork

40 cotter pin

41 rectangular tube

42 limit switch

43 limit switch

What is claimed is:

1. An adjusting device for positioning a load comprising:
a spindle;
a spindle nut which is arranged on the spindle;
a gear housing in which either the spindle nut is supported so as to be rotatable and not axially displaceable, wherein the spindle is axially adjustable by rotating the spindle nut for positioning the load, or in which the spindle is supported so as to be rotatable and not axially displaceable, wherein the spindle nut is axially adjustable by rotating the spindle for positioning the load; and
said gear housing having on two oppositely located housing sides blind holes into which the swivel bearing bushes are pressed for receiving swivel pins.

2. The adjusting device according to claim 1, wherein the gear housing has a housing base part which is a cast metal part and in which the blind holes are arranged with the swivel bearing bushes pressed into them.

3. The adjusting device according to claim 1, wherein the housing base part is formed in one piece.

4. The adjusting device according to claim 1, wherein the swivel bearing bushes are bronze-coated steel bushes.

5. The adjusting device according to claim 1, wherein the swivel bearing bushes are shaped like pipe pieces.

6. The adjusting device according to claim 1, wherein the axes of the swivel bearing bushes extend at right angles to the longitudinal axis of the spindle.

7. The adjusting device according to claim 1, wherein the axes of the swivel bearing bushes extend at right angles to a driveshaft for driving the adjusting device.

8. The adjusting device according to claim 1, wherein the housing sides in which blind holes are arranged with the swivel bearing bushes pressed into them extend at right angles to at least one housing side on which the spindle exits from the gear housing.

9. The adjusting device according to claim 1, wherein the housing sides in which the blind holes are arranged with the swivel bearing bushes pressed into them extend at right angles to at least one housing side which is penetrated by a driveshaft for driving the adjusting device.

10. The adjusting device according to claim 1, wherein the axes of the swivel bearing bushes inserted into the blind holes are aligned with one another.

11. The adjusting device according to claim 1, wherein when the axes of the swivel bearing bushes inserted into the blind holes are at a distance from the load-side edge of the respective housing side at which they are arranged, which distance is less than half of the height of the gear housing measured in axial direction of the spindle.

12. The adjusting device according to claim 11, wherein the distance of the axes from the load-side edge is less than one fifth of the height of the gear housing.
